(19) United States
(12) Patent Application Publication
(10) Pub. No.: US 2014/0181456 A1
(43) Pub. Date: Jun. 26, 2014

(54) MEMORY, MEMORY CONTROLLER, MEMORY SYSTEM INCLUDING THE MEMORY AND THE MEMORY CONTROLLER, AND OPERATING METHOD OF THE MEMORY SYSTEM

(71) Applicant: SK HYNIX INC., Gyeonggi-do (KR)

(72) Inventor: Ki-Chang KWEAN, Gyeonggi-do (KR)

(73) Assignee: SK HYNIX INC., Gyeonggi-do (KR)

(21) Appl. No.: 13/843,360

(22) Filed: Mar. 15, 2013

(30) Foreign Application Priority Data
Dec. 26, 2012 (KR) 10-2012-0153261

(51) Int. Cl. G06F 12/00

(52) U.S. Cl. CPC G06F 12/00
USPC 711/202

(57) ABSTRACT

A memory controller may include a reception unit configured to receive count information on the number of failed addresses in a memory, an address generation unit configured to generate an address having a value between a minimum address value and a maximum address value, wherein the maximum address value is adjusted based on an original maximum value and the count information, and a transmission unit configured to transmit the generated address to the memory.

### CROSS-REFERENCE TO RELATED APPLICATIONS

The present application claims priority of Korean Patent Application Nos. 10-2012-0153261, filed on Dec. 26, 2012, which is incorporated herein by reference in their entireties.

### BACKGROUND

1. Field

Exemplary embodiments of the present invention relate to a memory, a memory controller, a memory system, and an operating method of the memory system, wherein use of a failed memory cell of the memory may be prevented without a redundancy cell.

2. Description of the Related Art

In general, as the degree of integration of semiconductor memories is increased, one semiconductor memory includes tens of millions of unit cells or more. If any one of the unit cells fails, a corresponding semiconductor memory does not perform a desired operation. In terms of the yield of products, however, it is very inefficient to discard a semiconductor memory having relatively few failed unit cells. Here, the unit cell is a minimum unit at which functions unique to a semiconductor memory are performed, and a unit cell of a semiconductor memory is a memory cell.

Several methods are being attempted to alleviate the concern. For example, a method of repairing a semiconductor memory including some failed memory cells by using memory cells previously installed in the semiconductor memory (hereinafter referred to as redundancy cells) is being used. More particularly, a repairing operation using redundancy cells is performed in such a way to previously install a spare row and a spare column in a specific cell array, and replace a failed memory cell with a spare memory cell for every row/column.

When a failed memory cell is detected through a test after wafer processing, an internal circuit executes a program for replacing a corresponding address with the address signal of a spare cell. Accordingly, in actual use, when an address signal corresponding to a failed line is received, a reserved line is selected instead of the failed line. A failed line refers to a transmission line connected to a failed memory cell. As a result, the entire semiconductor memory can be repaired although some failed memory cells are included in the semiconductor memory.

The method using redundancy cells as described above is being widely used, but is disadvantageous in terms of a chip size because redundant memory cells other than necessary memory cells must be reserved and included in a semiconductor memory, which occupy more space. For this reason, other methods for repairing failed memory cells of a semiconductor memory are in demand.

Meanwhile, a plurality of memory cells included in a semiconductor memory corresponds to an address according to a corresponding relation predefined within the semiconductor memory, and a memory controller supplies an address for designating specific memory cells of the plurality of memory cells, together with a command signal, to the semiconductor memory in order to access the specific memory cells. In this case, a method of repairing a semiconductor memory by using the fact that a plurality of memory cells of the semiconductor memory corresponds to an address having a specific value can be taken into consideration.

### SUMMARY

Exemplary embodiments of the present invention are directed to a memory without redundancy memory cells that is capable of preventing use of a failed memory cell by changing a failed address corresponding to the failed memory cell, a memory controller, a memory system including the memory and the memory controller, and an operating method of the memory system.

The embodiments of the present invention are also directed to a memory, a memory controller, a memory system including the memory and the memory controller, and an operating method of the memory system, wherein information on a failed address of each chip does not need to be stored in the memory controller.

In accordance with an embodiment of the present invention, a memory controller may include a reception unit configured to receive count information on the number of failed addresses in a memory, an address generation unit configured to generate an address having a value between a minimum address value and a maximum address value, wherein the maximum address value is adjusted based on an original maximum value and the count information, and a transmission unit configured to transmit the generated address to the memory.

In accordance with another embodiment of the present invention, a memory may include a cell array configured to include a plurality of memory cells, first to N^{th} storage units configured to store a failed address, an internal address generation unit configured to generate an internal address by adding an external address and a conversion value together, the conversion value being a maximum value of K (1≦K<N) satisfying a condition that the sum of the external address and the K is greater than the failed address stored in the K^{th} storage unit of the first to the N^{th} storage units, and a control unit configured to access memory cells designated by the internal address among the plurality of memory cells in response to an access command.

In accordance with yet another embodiment of the present invention, a memory system may include a memory configured to include a plurality of memory cells, to access memory cells designated by an internal address among the plurality of memory cells in response to a plurality of command signals, to count the number of failed addresses, and to generate count information based on a result of the count, and a memory controller configured to set a maximum address value in response to the count information, to generate an address having a value between a minimum address value and the maximum address value when performing an access operation, and to input the plurality of command signals and the generated address to the memory.

In accordance with still another embodiment of the present invention, an operating method of a memory system may include counting the number of failed addresses in the memory, generating count information based on a result of the count, and applying the count information to the memory controller, setting a difference between a original maximum value and the count information as a maximum address value with the memory controller, and generating an address having a value between a minimum address value and the maximum address value with the memory controller.

In accordance with yet further another embodiment of the present invention, a memory system may include each of first to M^{th} memory chips configured to include a plurality of memory cells, access memory cells designated by an internal address among the plurality of memory cells in response to a plurality of command signals when a corresponding memory chip is selected, to count the number of failed addresses, and to generate respective pieces of first to M^{th} count information, and a memory controller configured to set a maximum address value in response to count information having a greatest value among the pieces of first to M^{th} count information, to generate an address having a value between a minimum address value and the maximum address value when performing an access operation, and to input the plurality of command signals and the generated address to the first to the M^{th} memory chips.

In accordance with yet further another embodiment of the present invention, a memory may include a cell array configured to include a plurality of memory cells, a plurality of storage units configured to store a failed address, an address mapping unit configured to map an external address to an internal address having a different value from the failed address stored in the plurality of storage units, and a control unit configured to access memory cells designated by the internal address among the plurality of memory cells in response to an access command.

In accordance with still another embodiment of the present invention, a memory system may include a memory configured to include a plurality of memory cells, to access memory cells designated by an internal address among the plurality of memory cells in response to a plurality of command signals, to count the number of failed addresses, and to generate count information based on a result of the count, and a memory controller configured to set a maximum address value in response to the count information, to generate an address having a value between a minimum address value and the maximum address value, and to input the plurality of command signals and the generated address to the memory, wherein the memory maps an address, which is received from the memory controller, to the internal address so that the received address has a different value from the failed address.

### BRIEF DESCRIPTION OF THE DRAWINGS

FIG. 1 shows a memory system in accordance with an embodiment of the present invention.

FIG. 2 shows a memory system in accordance with another embodiment of the present invention.

FIG. 3 shows a memory controller in accordance with an embodiment of the present invention.

FIG. 4 shows a memory in accordance with an embodiment of the present invention.

FIG. 5 is a diagram illustrating the operation of the memory of FIGS. 1 to 4.

FIG. 6 is a flowchart illustrating an operating method of the memory system in accordance with an embodiment of the present invention.

### DETAILED DESCRIPTION

Exemplary embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically mentioned in a sentence.

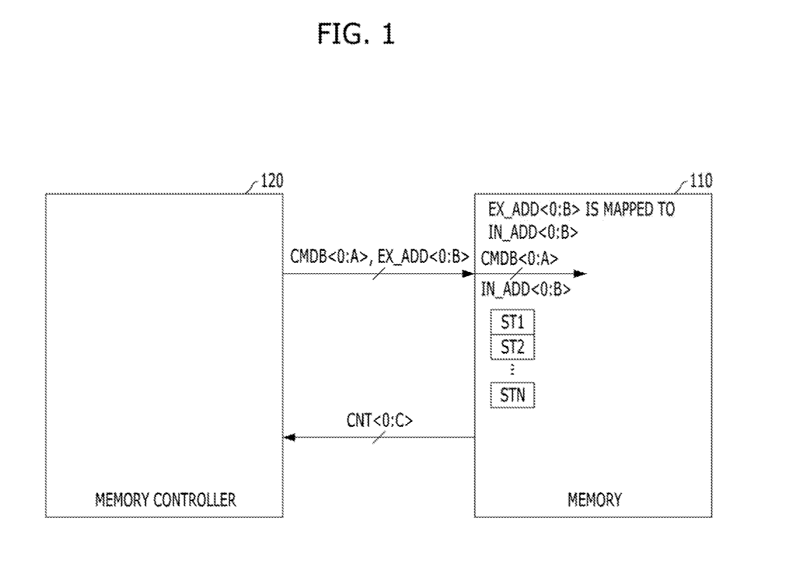

FIG. 1 shows a memory system in accordance with an embodiment of the present invention.

As shown in FIG. 1, the memory system includes a memory 110 and a memory controller 120. The memory 110 is configured to include a plurality of memory cells (not shown in FIG. 1), to access at least one memory cell of the plurality of memory cells designated by corresponding internal address IN_ADD<0:B> in response to at least one of a plurality of command signals CMDB<0:A>, to count the number of failed addresses (hereinafter “a number of” or “the number of” refer to how many failed addresses are present), and to generate count information CNT<0:C> based on a result of the count. The memory controller 120 is configured to adjust value of an external address EX_ADD<0:B> in response to the count information CNT<0:C> when performing an external address adjusting operation, to generate the adjusted external address EX_ADD<0:B> having a value between a minimum address value and the maximum address value when performing an access operation, and to access the memory 110 with the plurality of command signals CMDB<0:A> and the adjusted external address EX_ADD<0:B>.

The memory system is described in detail below with reference to FIG. 1.

The memory system first adjust value of the external address in the memory controller 120 and then accesses some of the plurality of memory cells included in the memory 110. The operation of the memory system is divided into an operation of adjusting value of the external address and an operation of accessing memory cells, which are described below.

(1) The Operation of Adjusting Value of the External Address

A failed memory cell is detected in the plurality of memory cells of the memory 110 through a test after fabrication, and the row address or column address (hereinafter referred to as a failed address) of the failed memory cell is stored. The memory 110 includes first to N^{th} storage units ST1 to STN for storing the failed address. It is hereinafter assumed that the failed address is the row address of the failed memory cell, and the external address EX_ADD 0:B> generated from the memory controller 120 is a row address. After the failed address is stored, the memory 110 counts the number of failed addresses and generates the count information CNT<0:C> based on a result of the count. The number of failed addresses is the same as the number of word lines that cannot be used among a plurality of word lines included in the memory 110.

The memory 110 transmits the count information CNT<0:C> to the memory controller 120. Meanwhile, the external address EX_ADD<0:B> generated from the memory controller 120 has a value between a minimum address value and a maximum address value. The minimum address value and the maximum address value may be internally generated within the memory controller 120 or may be preset by the memory controller 120 based on external information. The maximum address is hereinafter referred to as an original maximum address in order to be distinguished from an adjusted maximum address discussed later.

The memory controller 120 adjusts the maximum address value of the external address EX_ADD<0:B> in response to the count information CNT<0:C>. More particularly, the memory controller 120 sets a difference between the original maximum value and the number of failed addresses based on the count information CNT<0:C> as the adjusted maximum address value. For example, if the number of word lines included in the memory 110 is 1024, the minimum address value may be ‘0’ (‘0000000000’ in a binary number) and the original maximum value may be ‘1023’ (‘1111111111’ in a binary number). If, as a result of a test, the number of failed addresses of the memory 110 is 5 (that is, the number of failed word lines is 5), the memory 110 generates the count information CNT<0:C> (‘0000000101’ in a binary number) corresponding to the number ‘5’ and transmits the generated count information CNT<0:C> to the memory controller 120. The memory controller 120 sets the adjusted maximum address value as ‘1018’ (‘1111111010’ in a binary number), that is, a difference between the original maximum value ‘1023’ and the count information CNT<0:C>‘5’. This is because the 5 word lines cannot be used in the memory 110, and thus only ‘0’ to ‘1018’ have to be used as the value of the external address EX_ADD<0:B>.

If a difference between the original maximum value and the number of failed addresses is set as the adjusted maximum address value as described above, the number of the available external addresses EX_ADD<0:B> generated from the memory controller 120 is the same as the number of word lines that may be used in the memory 110 (that is, the number of word lines without failure). Now the memory controller 120 has information about the number of addresses available for access to the memory 110 but still does not have information on which one of the plural memory cells in the memory 110 is the failed cell and which one of the addresses is the failed address. Although the maximum address value is adjusted, the memory controller 120 still has a risk to generate the failed address. According to the embodiment of the present invention, the adjusted external address EX_ADD<0:B> is further converted into an internal address IN_ADD<0:B> to prevent use of the failed memory cell in the memory 110, which is described later.

In the above-described example, if failed addresses are ‘99’, ‘289’ ‘468’, ‘788’, and ‘1011’ and the adjusted maximum address value is ‘1018’, a total of the number of word lines without fail in the memory 110 and the number the adjusted external addresses EX_ADD<0:B> is 1019. Here, the memory controller 120 does not generate, as the adjusted external addresses EX_ADD 0:B>, ‘1019’ to ‘1.023’ greater than the adjusted maximum address value ‘1.018’, but still has a chance to generate the adjusted external addresses EX_ADD<0:B> having the same values as the failed addresses ‘99’, ‘289’, ‘468’, ‘788’, and ‘1011’ because the memory controller 120 does not have information on which one of the adjusted external addresses EX_ADD<0:B> is the failed address.

(2) The Operation of Accessing Memory Cells

The operation of accessing memory cells refers to an operation of writing data into the memory cells included in the memory 110 or reading data from the memory cell and activating the word lines. The memory controller 120 inputs one or more of the command signals CMDB<0:A>, the external address EX_ADD<0:B>, and data to the memory 110. When performing a read operation, the memory controller 120 inputs the plurality of command signals CMDB<0:A>, which corresponds to a read command, and the external address EX_ADD<0:B> to the memory 110. When performing a write operation, the memory controller 120 inputs the plurality of command signals CMDB<0:A> corresponding to a write command the external address EX_ADD<0:B>, and data to the memory 110. For reference, the plurality of command signals CMDB<0:A> may include a chip select signal CSB, an active control signal ACTB, a row address strobe signal RASB, a column address strobe signal CASB, and a write enable signal WEB. According to the embodiment of the present invention, the external address EX_ADD<0:B> in the operation of accessing memory cells has the adjusted maximum address resulted from the operation of adjusting value of the external address.

The memory 110 accesses memory cells corresponding to the external address EX_ADD<0:B> among the plurality of memory cells, in response to the plurality of command signals CMDB<0:A>. Here, the external address EX_ADD<0:B> has a value between the minimum address value and the adjusted maximum address value set in the operation of adjusting value of the external address, and thus the external address EX_ADD<0:B> indicating the failed address may still be inputted to the memory 110 as described above. The memory 110 receives the external address EX_ADD<0:B> and converting the external address EX_ADD<0:B> into the internal address IN_ADD<0:B>. The conversion of the external address EX_ADD<0:B> into the internal address IN_ADD<0:B> in order to prevent use of the failed memory cell is described in more detail below.

The memory 110 includes the first to the N^{th} storage units ST1 to STN for storing the failed address. The memory 110 generates the internal address IN_ADD<0:B> by adding the external address EX_ADD<0:B> and a conversion value together. The conversion value is a maximum value of K (1≦K<N) that satisfies a condition that the sum of the external address EX_ADD<0:B>, and K is greater than the failed address stored in the K^{th} storage unit STK of the first to the N^{th} storage units ST1 to STN. If the sum of the external address EX_ADD<0:B> and K is greater than the failed address stored in the K^{th} storage unit STN, the memory 110 generates the internal address IN_ADD<0:B> by adding K and the external address EX_ADD<0:B> together. If the sum of the external address EX_ADD<0:B and 1 is equal to or smaller than the failed address stored in the first storage unit STN1, the memory 110 uses the external address EX_ADD<0:B> as the internal address IN_ADD<0:B>.

According to the embodiment of the present invention, the internal address IN_ADD<0:B> converted from the external address EX_ADD<0 B>, which has the adjusted maximum address value, by the conversion value does not indicate the failed address at all, and thus access to the failed memory cell may be prevented when the internal address IN_ADD<0:B> is used to access the memory 110. Therefore, the embodiment of the present invention may provide an operable memory that has the failed memory cells even without the redundancy cells, which means that information on the failed address needs not to be stored in the memory controller 120.

A process of generating the internal address IN_ADD<0:B> is described below as an example. It is assumed that the memory 110 includes 5 storage units, that is, first to fifth storage units ST1 to ST5 (that is, N=5), and the 5 failed addresses, for example ‘99’, ‘289’, ‘468’, ‘788’, and ‘1011’, are stored in the first to the fifth storage units ST1 to ST5, respectively. For reference, the failed addresses ‘99’, ‘289’, ‘468’, ‘788’, and ‘1011’ are stored in the first to the fifth storage units ST1 to ST5, respectively, in ascending order of the failed address.

If the external address EX_ADD<0:B> falls in the range of ‘0’ to ‘98’, where the sum of the external address EX_ADD<0:B> and 1 is equal to or smaller than ‘99’, that is, the failed address stored in the first storage units ST1, the memory 110 transfers the external address EX_ADD<0:B> without a change and generates the internal address IN_ADD<0:B> having the same value as the external address EX_ADD<0:B>. That is, the addresses EX_ADD<0:B>‘0’ to ‘98’ are mapped to internal addresses IN_ADD<0:B>‘0’ to ‘98’.

If the external address EX_ADD<0:B> falls in the range of ‘99’ to ‘287’, where a maximum value K satisfying the condition that the sum of the external address EX_ADD<0:B> and K is greater than the failed address stored in the K^{th} storage unit STK is 1, the conversion value is 1. In this case, the memory 110 generates the internal address IN_ADD<0:B> by adding the external address EX_ADD<0:B> and the conversion value 1 together. That is, the addresses EX_ADD<0:B>‘99’ to ‘287’ are mapped to internal addresses IN_ADD<0:B> ‘100’ to ‘288’.

If the external address EX_ADD<0:B> falls in the range of ‘288’ to ‘465’, where a maximum value K satisfying the condition is 2, the conversion value is 2. The memory 110 generates the internal address IN_ADD<0:B> by adding the external address EX_ADD<0:B> and the conversion value 2 together. That is, the addresses EX_ADD<0:B>‘288’ to ‘465’ are mapped to internal addresses IN_ADD<0:B>‘290’ to ‘467’.

If the external address EX_ADD<0:B> falls in the range of ‘466’ to ‘784’, where a maximum value K satisfying the condition is 3, the conversion value is 3. The memory 110 generates the internal address IN_ADD<0:B> by adding the external address EX_ADD<0:B> and the conversion value 3 together. That is, the addresses EX_ADD<0:B>‘466’ to ‘784’ are mapped to internal addresses IN_ADD<0:B>‘469’ to ‘787’.

If the external address EX_ADD<0:B> falls in the range of ‘785’ to ‘1006’, where a maximum value K satisfying the condition is 4, the conversion value is 4. The memory 110 generates the internal address IN_ADD<0:B> by adding the external address EX_ADD<0:B> and the conversion value 4 together. That is, the addresses EX_ADD<0:B>‘785’ to ‘1006’ are mapped to internal addresses IN_ADD<0:B>‘789’ to ‘1010’.

If the external address EX_ADD<0:B> falls in the range of ‘1007’ to ‘1018’, where the sum of the external address EX_ADD<0:B> and 5 is greater than the failed address stored in the fifth storage units ST5, the memory 110 generates the internal address IN_ADD<0:B> by adding the external address EX_ADD<0:B> and the conversion value 5 together. That is, the addresses EX_ADD<0:B>‘1007’ to ‘1018’ are mapped to internal addresses IN_ADD<0:B ‘1012’ to ‘1023’.

The internal addresses IN_ADD<0:B> converted from the external address EX_ADD<0:B>, which has the adjusted maximum address value, by the conversion value does not indicate the failed address ‘99’, ‘289’, ‘468’, ‘788’, and ‘1011’. Accordingly, the memory 110 may be operable in response to the external address EX_ADD<0:B> supplied from the memory controller 120 despite the failed memory cell.

Size of the memory 110 may be reduced because the memory system in accordance with the embodiment of the present invention does not include redundancy memory cells. Furthermore, in the memory system in accordance with the embodiment of the present invention, information on failed addresses does not need to be stored in the memory controller 120 because the memory controller 120 uses the external address EX_ADD<0:B> with the adjusted maximum address value, and the memory 110 converts the external address EX_ADD<0 B> into the internal addresses IN_ADD<0:B>, which does not indicate the failed address, for substantial access address to the memory 110.

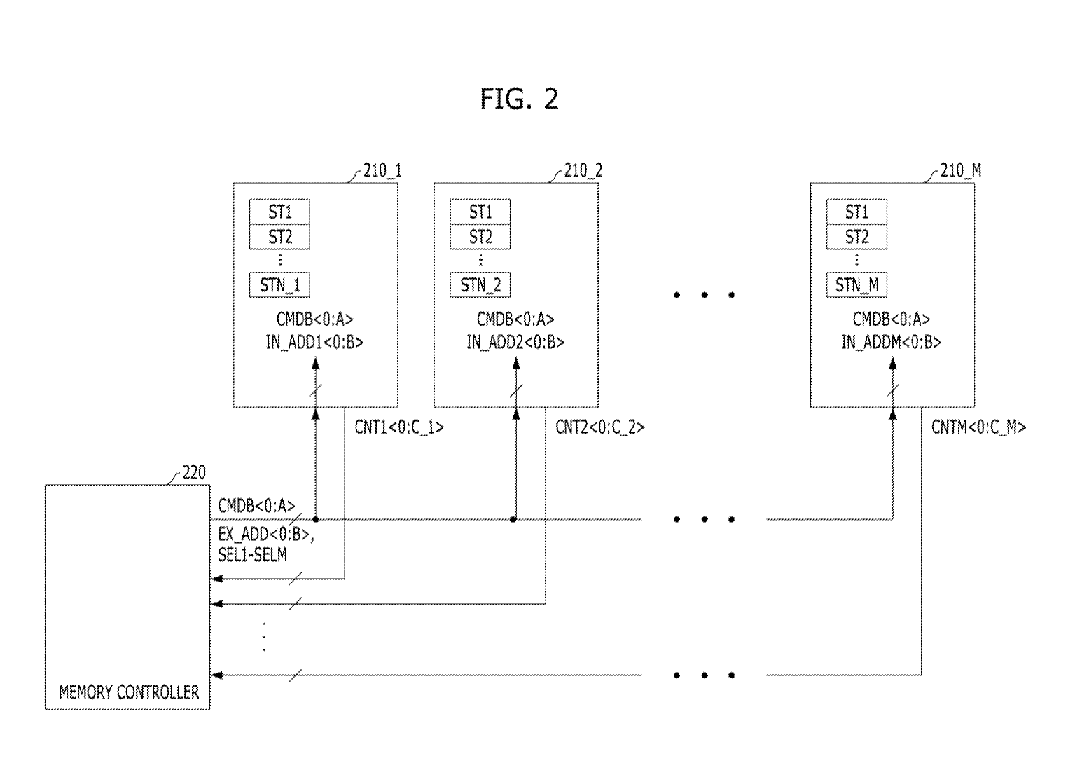

FIG. 2 shows a memory system in accordance with another embodiment of the present invention. The memory system of FIG. 2 includes a plurality of memory chips, each of which corresponds to the memory 110 shown in FIG. 1. The memory system of FIG. 2 may be a memory module.

The memory system of FIG. 2 includes first to M^{th} memory chips 210_1 to 210_M each including a plurality of memory cells (not shown in FIG. 2), and a memory controller 220. When a memory chip is selected by one of first to M^{th} selection signals SEL1 to SELM out of the first to the M^{th} memory chips 210_1 to 210_M, the selected memory chip performs the operation of accessing memory cells. The selected memory chip out of the first to the M^{th} memory chips 210_1 to 210_M accesses memory cells designated by each of internal addresses IN_ADD1<0:B> to IN_ADDM<0:B> in response to a plurality of command signals CMDB<0:A>. Before the operation of accessing memory cells, each of the first to the M^{th} memory chips 210_1 to 210_M performs the operation of adjusting value of the external address. Each of the first to the M^{th} memory chips 210_1 to 210_M counts the number of failed addresses through a test after fabrication and generates each of pieces of first to M^{th} count information CNT1<0:C_{—}1> to CNTM<0:C_M>. In the operation of adjusting value of the external address, the memory controller 220 adjusts the maximum address value for the external address EX_ADD<0:B> in response to count information with the greatest value among the pieces of first to M^{th} count information CNT1<0:C_{—}1> to CNTM<0:C_M>. The adjusted external address EX_ADD<0:B> has a value between the minimum address value and the maximum address value. In the operation of accessing memory cells, the memory controller 220 inputs the plurality of command signals CMDB<0:A> and the adjusted external address EX_ADD<0:B> to the first to the M^{th} memory chips 210_1 to 210_M as well as the first to M^{th} selection signals SEL1 to SELM.

The memory system is described in detail below with reference to FIG. 2.

The memory system of FIG. 2 is similar to the memory system of FIG. 1 except that it includes the plurality of memory chips 210_1 to 210_M. In the memory system of FIG. 2, the memory controller 220 generates the first to M^{th} select signals SEL1 to SELM for selecting one or more of the first to the M^{th} memory chips 210_1 to 210_M. The first to the M^{th} select signals SEL1 to SELM correspond to the respective first to M^{th} memory chips 210_1 to 210_M. When one of the first to the M^{th} select signals SEL1 to SELM is activated, a memory chip corresponding to the activated select signal among the first to the M^{th} memory chips 210_1 to 210_M is selected, and an access operation is performed on some of the plurality of memory cells included in the selected memory chip. The operation of the memory system is divided into the operation of adjusting value of the external address and the operation of accessing memory cells, which are described below. In particular, feature of the memory system of FIG. 2 difference from the memory system of FIG. 1 is primarily described in order to avoid redundancy.

(1) The Operation of Adjusting Value of the External Address

A failed memory cell is detected in the plurality of memory cells of each of the first to the M^{th} memory chips 210_1 to 210_M through a test, and the failed address of the failed memory cell is stored in a corresponding memory chip. Each of the memory chips includes first to N^{th} storage units ST1 to STN for storing the failed address. For example, the first to the M^{th} memory chips 210_1 to 210_M are storing STN_{—}1 to STN_M numbers of the failed addresses, respectively. Similar to the embodiment of FIG. 1, the external address EX_ADD<0:B> is assumed to be a row address. The first to the M^{th} memory chips 210_1 to 210_M count the numbers of failed addresses and generates the first to M count information CNT1<0:C1> to CNTM<0:C_M> based on a result of the counts.

The first to the M^{th} memory chips 210_1 to 210_M transmit the pieces of the first to M^{th} count information CNT1<0:C_{—}1> to CNTM<0:C_M> to the memory controller 220. Like the memory controller 120 of FIG. 1, the memory controller 220 adjusts the original maximum address value of the external address EX_ADD<0:B> based on the pieces of first to M^{th} count information CNT1<0:C_{—}1> to CNTM<0:C_M>. Here, the memory controller 220 of FIG. 2 sets a difference between the original maximum value and count information having the greatest value among the pieces of first to M^{th} count information CNT1<0:C_{—}1> to CNTM<0:C_M> as the adjusted maximum address value.

For example, it is assumed that 4 memory chips included in a memory system and 1024 word lines included in each of the memory chips. Here, the minimum address value set in the memory controller 220 may be ‘0’, and the original maximum value may be ‘1023’. It is assumed that as a result of a test, the number of failed addresses of the first memory chip 210_1 is 3, the number of failed addresses of the second memory chip 210_2 is 8, the number of failed addresses of the third memory chip 210_3 is 14, and the number of failed addresses of the fourth memory chip 210_4 is 5. The memory controller 120 sets ‘1009’ as the adjusted maximum address value based on the difference between the original maximum value ‘1023’ and the greatest value ‘14’ among the pieces of first to fourth count information CNT1<0:C_{—}1> to CNT4<0:C> (‘3’, ‘8’, ‘14’, and ‘5’). The greatest value among the pieces of first to fourth count information CNT1<0:C_{—}1> to CNT4<0:C>, which indicates the largest number of failed addresses, is selected on the ground that the adjusted external address EX_ADD<0:B> is inputted without distinguishing the first to the M^{th} memory chips 210_1 to 210_M. Accordingly, the memory controller 220 generates the external address EX_ADD<0:B> having a value between the minimum address value ‘0’ and the adjusted maximum address value ‘1009’ to be transmitted to the first to the fourth memory chips 210_1 to 210_4.

(2) The Operation of Accessing Memory Cells

The operation of accessing memory cells refers to an operation of writing data into the plurality of memory cells included in the first to the M^{th} memory chips 210_1 to 210_M or reading data from the plurality of memory cells. The operation of accessing memory cells in the memory system shown in FIG. 2 is substantially the same as the system of FIG. 1. The plurality of command signals CMDB<0:A> and the external address EX_ADD<0:B> are inputted to the first to the M^{th} memory chips 210_1 to 210_M in common, but an access operation is performed on only a memory chip selected among the first to the M^{th} memory chips 210_1 to 210_M in response to a corresponding select signal.

Conversion of the external address EX_ADD<0 B> into corresponding one of the first to the M^{th} internal addresses IN_ADD1<0 B> to IN_ADDM<0:B> in the selected memory chip is substantially the same as that described with reference to FIG. 1. If a failed address is stored in one of the first to the M^{th} memory chips 210_1 to 210_M the corresponding memory chip converts the external address EX_ADD<0:B> into an internal address and does not use the failed address. For reference, the first to the M^{th} internal addresses IN_ADD1<0:B> to IN_ADDM<0 B> are addresses generated within the respective first to M^{th} memory chips 210_1 to 210_M.

The memory system of FIG. 2 has similar effects as the memory system shown in FIG. 1.

That is, in the memory chips and the memory system in accordance with another embodiment of the present invention, the first to the M^{th} internal addresses IN_ADD1<0:B> to IN_ADDM<0:B> converted from the external address EX_ADD<0:B>, which have the adjusted maximum address value, by the conversion value do not indicate the failed address, and thus access to the failed memory cell may be prevented when the first to the M^{th} internal addresses IN_ADD1<0:B> to IN_ADDM<0:B> is used for access the first to M^{th} memory chips 210_1 to 210_M. Therefore, the embodiment of the present invention may provide an operable memory system that has failed memory cells even without the redundancy cells, which means that information on the failed address needs not be stored in the memory controller 220.

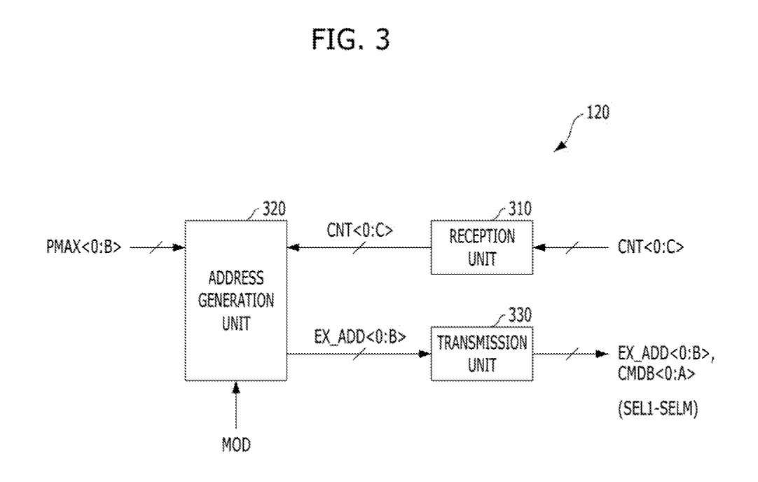

FIG. 3 shows a memory controller in accordance with an embodiment of the present invention. The memory controller of FIG. 3 corresponds to the memory controller 120 included in the memory system of FIG. 1.

As shown in FIG. 3, the memory controller 120 includes a reception unit 310 for receiving the count information CNT<0:C> on the number of failed addresses counted in a memory 110, an address generation unit 320 for generating the external address EX_ADD<0:B> having the value between a minimum address value and the adjusted maximum address value, which is set based on an original maximum values PMAX<0:B> and the count information CNT<0:C>, and a transmission unit 330 for transmitting the adjusted maximum address EX_ADD<0:B> to the memory.

The memory controller 120 is described in detail below with reference to FIGS. 1 and 3.

When the operation of adjusting value of the external address is performed, the reception unit 310 receives the count information CNT<0:C> from the memory 110 and transfers the count information CNT<0:C> to the address generation unit 320. When the operation of accessing memory cells is performed, the reception unit 310 receives data from the memory 110.

When the operation of adjusting value of the external address is performed, the address generation unit 320 sets a difference between the original maximum value PMAX<0:B> and the count information CNT<0:C> as the adjusted maximum address value. When the operation of accessing memory cells is performed, the address generation unit 320 generates the external address EX_ADD<0:B> having a value between a minimum address value and the adjusted maximum address value. A mode signal MOD indicates the operation of adjusting value of the external address or the operation of accessing memory cells. When the mode signal MOD is activated, the address generation unit 320 sets the adjusted maximum address value. When the mode signal MOD is deactivated, the address generation unit 320 generates the external address EX_ADD<0:B> having a value between a minimum address value and the adjusted maximum address value.

When the operation of accessing memory cells is being performed, the transmission unit 330 transmits the external address EX_ADD<0:B> of the address generation unit 320, the plurality of command signals CMDB<0:A>, the external address EX_ADD<0:B>, and data that enable the memory 110 to perform one or more of an active operation, a read operation, and a write operation to the memory 110.

A memory controller partly shown in FIG. 3 may correspond to the memory controller 220 of FIG. 2. In this case, when the operation of adjusting value of the external address is performed, the reception unit 310 receives pieces of first to M^{th} count information CNT1<0:C_{—}1> to CNTM<0:C_M> and transfers the pieces of first to M^{th} count information CNT1<0:C_{—}1> to CNTM<0:C_M> to the address generation unit 320. The address generation unit 320 may set a difference between the original maximum value PMAX<0:B> and count information having the greatest value among the pieces of first to M^{th} count information CNT1<0:C_{—}1> to CNTM<0:C_M> as the adjusted maximum address value. The transmission unit 330 may transmit first to M^{th} select signals SEL1 to SELM to the respective first to M^{th} memory chips 210_1 to 210_M in addition to the plurality of command signals CMDB<0:A>, the external address EX_ADD<0:B> and data.

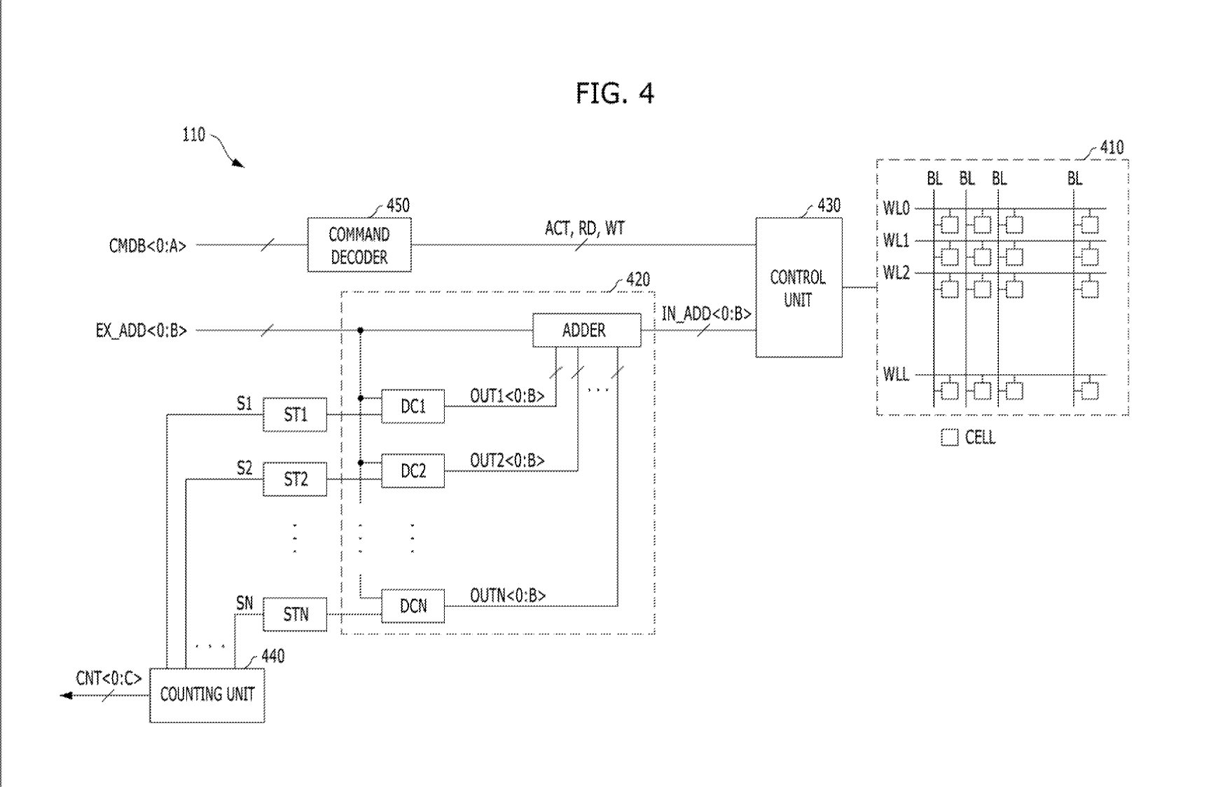

FIG. 4 shows a memory in accordance with an embodiment of the present invention. The memory of FIG. 4 corresponds to the memory 110 of FIG. 1, and each of the first to the M^{th} memory chips 210_1 to 210_M of FIG. 2.

As shown in FIG. 4 the memory 110 includes a cell array 410 configured to include a plurality of memory cells CELL, the first to the N^{th} storage units ST1 to STN configured to store a failed address, an internal address generation unit 420 configured to generate the internal address IN_ADD<0:B> by adding the external address EX_ADD<0:B> and the conversion value together, a control unit 430 configured to access memory cells designated by the internal address IN_ADD<0:B> among the plurality of memory cells CELL of the cell array 410 in response to an access command, and a counting unit 440 configured to count the number of storage units in which failed addresses are stored among the first to the N^{th} storage units ST1 to STN and to generate the count information CNT<0:C> based on a result of the count. As described above in connection with FIG. 1, the conversion value is a maximum value of K (1≦K<N) that satisfies a condition that the sum of the external address EX_ADD<0:B> and K is greater than the failed address stored in the K^{th} storage unit STK of the first to the N^{th} storage units ST1 to STN. The memory cells CELL are coupled with a corresponding bit line BL and a word line WL. The memory further includes a command decoder 450 configured to generate internal commands ACT, RD, and WT in response to the plurality of command signals CMDB<0:A>.

The memory is described in detail below with reference to FIGS. 1 and 4.

The operation of the memory is divided into the operation of adjusting value of the external address and the operation of accessing memory cell, which are described below.

(1) The Operation of Adjusting Value of the External Address

A failed address detected as a result of a test is stored in the first to the N^{th} storage units ST1 to STN. If the number of failed addresses is 2 or more, the failed addresses are stored in the first to the N^{th} storage units ST1 to STN in order of higher value. An example in which the failed address is the row address of a failed memory cell is described below.

A storage unit in which the failed address is stored among the first to the N^{th} storage units ST1 to STN activates a corresponding storage signal from first to N^{th} storage signals S1 to SN. The number of activated storage signals of the first to the N^{th} storage signals S1 to SN corresponds to the number of failed addresses. The counting unit 440 counts the number of activated storage signals of the first to the N^{th} storage signals S1 to SN and generates the count information CNT<0:C> based on a result of the count. The memory outputs the count information CNT<0:C>.

As described above with reference to FIGS. 1 and 3, the memory controller 110 adjusts the maximum address value of the external address EX_ADD<0:B> in response to the count information CNT<0:C>. According to the embodiment of the present invention, the external address EX_ADD<0:B> in the operation of accessing memory cells has the adjusted maximum address resulted from the operation of adjusting value of the external address.

(2) The Operation of Accessing Memory Cells

When performing the operation of accessing memory cells, the memory controller 120 inputs one or more of the plurality of command signals CMDB<0:A> corresponding to the access commands ACT, RD, and/or WT, the external address EX_ADD<0:B> and data, to the memory 110. The access commands include one or more of an active command, a read command, and a write command. The command decoder 450 generates the internal commands ACT, RD, and WT corresponding to the active command, the read command, and the write command by decoding the plurality of command signals CMDB<0:A>. For reference, the memory controller 120 inputs the plurality of command signals CMDB<0:A>, including the active control signal ACTB, the row address strobe signal RASB, the column address strobe signal CASB, and the write enable signal WEB, to the memory 110. The supply of a specific command from the memory controller 120 to the memory 110 refers to the supply of the specific command, which includes a combination of the plurality of command signals CMDB<0:A>, to the memory 110. For example, the supply of the active command from the memory controller 120 to the memory 110 refers to the supply of the active command, which includes a combination of the command signals ACTB, RASB, CASB and WEB, to the memory 110. The command decoder 450 of the memory 110 generates the internal commands ACT, RD, and/or WT within the memory 110 by decoding the command signals ACTB, RASB, CASB, and WEB.

The internal address generation unit 420 generates the internal address IN_ADD<0:B> in response to the external address EX_ADD<0:B>. More particularly, the internal address generation unit 420 generates the internal address IN_ADD<0:B> by adding the external address EX_ADD<0:B> and the conversion value together. The conversion value is a maximum value of K (1≦K<N) that satisfies a condition that the sum of the external address EX_ADD<0:B> and K is greater than the failed address stored in the K^{th} storage unit STK of the first to the N^{th} storage units ST1 to STN. If the sum of the external address EX_ADD<0:B> and K is greater than the failed address stored in the K^{th} storage unit STK, the internal address generation unit 420 generates the internal address IN_ADD<0:B> by adding K and the external address EX_ADD<0:B> together. Furthermore, if the sum of the external address EX_ADD<0:B> and 1 is smaller than the failed address stored in the first storage units ST1, the internal address generation unit 420 forwards the external address EX_ADD<0:B> as the internal address IN_ADD<0:B>.

For this operation, the address generation unit 420 includes first to N^{th} determination units DC1 to DCN configured to correspond to the respective first to N^{th} storage units ST1 to STN and an adder ADDER configured to generate the internal address IN_ADD<0:B> by adding the external address EX_ADD 0:B> and a value, which is the maximum value among outputted values from activated determination units from the first to the N^{th} determination units DC1 to DCN. The result of addition by the ADDER in the address generation unit 420 is the internal address IN_ADD<0:B>.

Each of the first to the N^{th} determination units DC1 to DCN makes a determination as follows. The K^{th} determination unit. DCK corresponding to the K^{th} unit STK among the first to the N^{th} determination units DC1 to DCN is activated when the sum of the external address EX_ADD<0:B> and K is greater than the failed address stored in the K^{th} storage unit STK. The activated K^{th} determination unit DCK outputs K as an output values OUTK<0:B> or the conversion value.

For this operation, the K^{th} determination unit DCK is activated when the sum of the external address EX_ADD<0 B> and K is greater than the failed address stored in the K^{th} storage unit STK. The N^{th} determination unit DCN is activated when the sum of the external address EX_ADD<0:B> and N is greater than the failed address stored in the N^{th} storage unit STN, which may be the greatest value among the failed addresses stored in the first to N storage units ST1 to STN. Thus, the N^{th} determination unit DCN outputs N. For reference, a maximum value among the output values of activated determination units of the first to the N^{th} determination units DC1 to DCK becomes a conversion value.

The control unit 430 accesses memory cells, which corresponds to the internal address IN_ADD<0:B>, in response to the internal commands ACT, RD, and/or WT. The internal address IN_ADD<0:B>, which is an exemplary row address, allows the control unit 430 to activate a corresponding word line among a plurality of word lines WL0 to WLL included in the cell array 410 in response to the internal commands ACT, RD, and/or WT. Detailed memory access process, which is well known to a person having ordinary skill in the art and does not directly fall in the scope of the embodiments of the present invention, is omitted.

The memory in accordance with the embodiment of the present invention converts the external address EX_ADD<0:B> into the internal address IN_ADD<0:B> not having a failed address value. Accordingly, access to the failed memory cell may be prevented when the internal addresses IN_ADD<0 B>, which is converted by the conversion value from the external address EX_ADD<0:B> with the adjusted maximum address value, is used for access to the memory chip. Therefore, the embodiment of the present invention may provide an operable memory system that has the failed memory cell even without the redundancy cells, which means that information on the failed address needs not be stored in the memory controller.

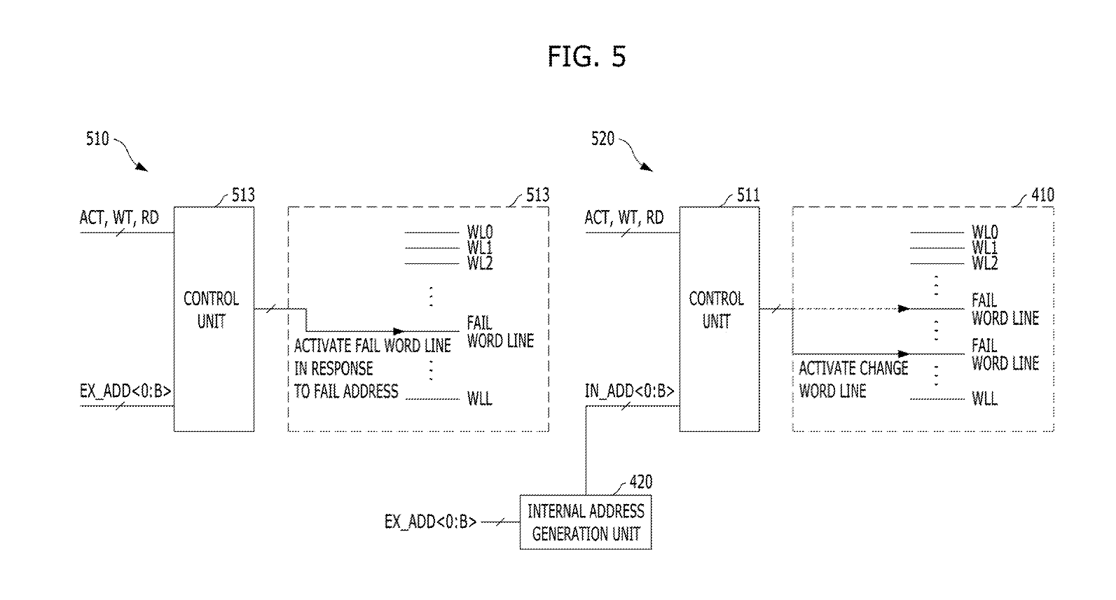

FIG. 5 is a diagram illustrating the operation of the memory of FIGS. 1 to 4.

FIG. 5 illustrates only the cell array, the internal address generation unit, the control unit, and the plurality of word lines WL0 to WLL included in the cell array among the internal elements of the memory in order to describe the operation of the memory in clearly and concisely. A first FIG. 510 shows a memory without use of the internal address IN_ADD<0:B>. A second FIG. 520 shows a memory with use of the internal address IN_ADD<0:B> in accordance with exemplary embodiments of the present invention.

As noted in connection with FIG. 1, the memory controller (not shown in FIG. 5) has information about the number of addresses available for access to the memory with the adjusted external address EX_ADD<0:B>, but still does not have information on which one of the plural memory cells in the memory is the failed cell and which one of the addresses is the failed address. Although the maximum address value is adjusted in the external address EX_ADD<0:B>, the memory controller may generate the failed address. As shown in the first FIG. 510, a concern arises when the control unit 513 activates a word line corresponding to the failed address, that is, a failed word line among the plurality of word lines WL0 to WLL included in the cell array 511 in response to the external address EX_ADD<0:B> having the same value as the failed address.

According to the embodiments of the present invention, however, the adjusted external address EX_ADD<0:B> is further converted into an internal address IN_ADD<0:B> to prevent use of the failed memory cell in the memory. As shown in the second FIG. 520, the internal address generation unit 420 generates the internal address IN_ADD<0:B> having a different value from the failed address by adding the external address EX_ADD<0:B> having the same value as the failed address and a conversion value together. Accordingly, in the memory in accordance with the embodiments of the present invention, although the external address EX_ADD<0:B> having the same value as the failed address, the failed word line is not activated. As shown in the 520 of FIG. 5, ‘the failed word line’ corresponding to the failed address is not activated, but a ‘change word line’ corresponding to the internal address IN_ADD<0:B> converted from the failed address is activated.

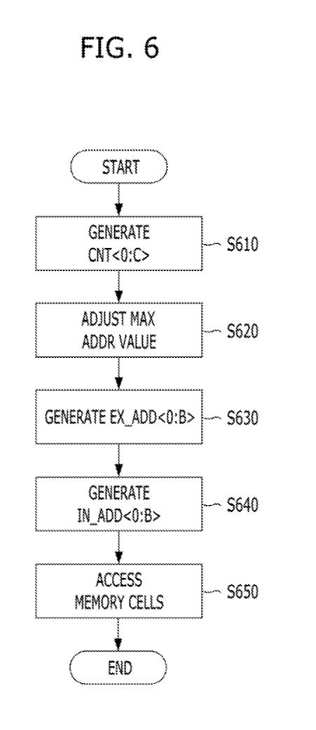

FIG. 6 is a flowchart illustrating an operating method of the memory system in accordance with another embodiment of the present invention.

As shown in FIG. 6, the operating method of the memory system having the memory 110 and the memory controller 120 may include generating the count information CNT<0:C> based on result of the count of the number of failed addresses in the memory 110 at step S610, adjusting the maximum address value of the external address EX_ADD<0:B> based on the difference between the original maximum values PMAX<0:B> and the count information CNT<0:C> in the memory controller 120 at step S620, generating the external address EX_ADD<0:B> having a value between a minimum address value and the adjusted maximum address value in the memory controller 120 at step S630, generating the internal address IN_ADD<0:B> by adding the external address EX_ADD<0:B> and a conversion value together in the memory 110 at step S640, and accessing memory cells designated by the internal address IN_ADD<0:B> in the memory 110 at step S650.

The operating method of the memory system is described below with reference to FIGS. 1, 4 and FIG. 6.

At the step S610, the memory 110 counts the number of storage units for storing a failed address among the first to the N^{th} storage units ST1 to STN, and generates the count information CNT<0:C> based on a result of the count. Here, the count information CNT<0:C> corresponds to the number of failed addresses. The memory 110 transmits the generated count information CNT<0:C> to the memory controller 120. At the step S620, the memory controller 120 sets the difference between the original maximum value PMAX<0:B> and the count information CNT<0:C> as the adjusted maximum address value. At the step S630, the memory controller 120 generates the external address EX_ADD<0:B> having a value between a minimum address value and the adjusted maximum address value set at the step S620.

The memory controller 120 supplies one or more of the plurality of command signals CMDB<0:A> the external address EX_ADD<0:B> and data to the memory 110. At the step S640, the memory 110 generates the internal address IN_ADD<0:B> by adding the external external address EX_ADD<0:B> and the conversion value together. At the step S650, memory cells corresponding to the internal address IN_ADD<0:B> among the plurality of memory cells included in the cell array 410 of the memory 110, are accessed.

The operating method of the memory system in accordance with the embodiment of the present invention has substantially the same effects as the memory system described above.

In accordance with exemplary embodiments of the present invention, the internal address IN_ADD<0:B> converted from the external address EX_ADD<0:B> which has the adjusted maximum address value, by the conversion value does not indicate the failed address, and thus access to the failed memory cell may be prevented when the internal address IN_ADD<0:B> is used for access to the memory. Therefore, the embodiment of the present invention may provide an operable memory that has the failed memory cells even without the redundancy cells.

Furthermore, exclusion of the redundancy cells a memory system allows the memory controller not to store information on the failed address although the plurality of memory chips has different failed addresses because the plurality of memory chips included in the memory system internally converts external addresses received from the memory controller.

While the present invention has been described with respect to the specific embodiments, it will be apparent to those skilled in the art that various changes and modifications may be made without departing from the spirit and scope of the invention as defined in the following claims.

What is claimed is:

1. A memory controller, comprising:
a reception unit configured to receive count information on a number of failed addresses in a memory;
an address generation unit configured to generate an address having a value between a minimum address value and a maximum address value, wherein the maximum address value is adjusted based on an original maximum value and the count information; and
transmission unit configured to transmit the generated address to the memory.

2. The memory controller of claim 1, wherein the address generation unit sets a difference between the original maximum value and the count information as the maximum address value.

3. The memory controller of claim 2, wherein the transmission unit transmits the generated address and a plurality of command signals that enables the memory to perform one or more of an active operation, a read operation, and a write operation to the memory.

4. A memory, comprising:
a cell array configured to include a plurality of memory cells;
first to N^{th} storage units configured to store a failed address;
an internal address generation unit configured to generate an internal address by adding an external address and a conversion value, wherein the conversion value being a maximum value of K (1≦K<N) satisfying a condition that a sum of the external address and the K is greater than the failed address stored in the K^{th} storage unit of the first to the N^{th} storage units; and
a control unit configured to access memory cells designated by the internal address among the plurality of memory cells in response to an access command.

5. The memory of claim 4, wherein the internal address generation unit generates the internal address by adding N and the external address together if a sum of the external address and the N is greater than the failed address stored in the N^{th} storage unit.

6. The memory of claim 5, wherein the internal address generation unit generates the internal address having a value identical with the external address if a sum of the external address and 1 is equal to or smaller than the failed address stored in the first storage unit.

7. The memory of claim 4, wherein the access command comprises one or more of an active command, a read command, and a write command.

8. The memory of claim 6, wherein the internal address generation unit comprises:
first to N^{th} determination units configured to correspond the respective first to N^{th} storage units; and
an adder configured to generate the internal address by adding the external address and a maximum value among outputted values from activated determination units of the first to the N^{th} determination units together,
wherein the K^{th} determination unit corresponding to the K^{th} storage unit of the first to the N^{th} determination units is activated when the sum of the external address and the K is greater than the failed address stored in the K^{th} storage unit, thus outputting the K.

9. The memory of claim 8, wherein the N^{th} determination unit corresponding to the N^{th} storage unit is activated when a sum of the external address and N is greater than the failed address stored in the N^{th} storage unit, thus outputting the N.

10. The memory of claim 9, further comprising a counting unit configured to count a number of storage units in which the failed address is stored among the first to the N^{th} storage units, and to generate the count information based on a result of the count.

11. The memory of claim 4, wherein if a number of the failed addresses is 2 or more, the failed addresses are stored in the first to the N^{th} storage units in order of failed address having a higher value.

12. A memory system, comprising:
a memory configured to include a plurality of memory cells, to access memory cells designated by an internal address among the plurality of memory cells in response to a plurality of command signals, to count a number of failed addresses, and to generate count information based on a result of the count; and
a memory controller configured to set a maximum address value in response to the count information, to generate an address having a value between a minimum address value and the maximum address value, and to input the plurality of command signals and the generated address to the memory.

13. The memory system of claim 12, wherein the memory controller sets a difference between an original maximum value and the count information as the maximum address value.

14. The memory system of claim 13, wherein the memory comprises first to N^{th} storage units for storing a failed address and generates the internal address by adding an external address and a conversion value together, wherein the conversion value being a maximum value of K (1≦K<N) satisfying a condition that a sum of the external address and the K is greater than the failed address stored in the K^{th} storage unit of the first to the N^{th} storage units.

15. The memory system of claim 14, wherein the memory generates the internal address by adding N and the external address together if a sum of the external address and the N is greater than the failed address stored in the N^{th} storage unit.

16. The memory system of claim 15, wherein the memory generates the internal address having a value substantially the same as the external address if a sum of the external address and 1 is equal to or smaller than the failed address stored in the first storage unit.

17. The memory system of claim 12, wherein the plurality of command signals corresponds to one or more of an active command, a read command, and a write command.

18. An operating method of a memory system comprising a memory and a memory controller, comprising:
counting a number of failed addresses in the memory, generating count information based on a result of the count, and applying the count information to the memory controller;
setting a difference between an original maximum value and the count information as a maximum address value with the memory controller; and
generating an address having a value between a minimum address value and the maximum address value with the memory controller.

19. The operating method of claim 18, wherein the memory comprises:
a plurality of memory cells; and
first to N^{th} storage units for storing the failed addresses.

20. The operating method of claim 19, further comprising:
inputting a plurality of command signals and the generated address to the memory;
generating an internal address by adding an external address and a conversion value together, wherein the conversion value being a maximum value of K (1≦K<N) satisfying a condition that a sum of the external address and the K is greater than the failed address stored in the K^{th} storage unit of the first to the N^{th} storage units; and
accessing memory cells designated by the internal address among the plurality of memory cells in response to the plurality of command signals.

21. The operating method of claim 20, wherein the plurality of command signals corresponds to one or more of an active command, a read command, and a write command.

22. A memory system, comprising:
each of first to M^{th} memory chips configured to include a plurality of memory cells, to access memory cells designated by an internal address among the plurality of memory cells in response to a plurality of command signals when a corresponding memory chip is selected, to count a number of failed addresses, and to generate respective pieces of first to M^{th} count information; and
a memory controller configured to set a maximum address value in response to count information having a greatest value among the pieces of first to M^{th} count information, to generate an address having a value between a minimum address value and the maximum address value, and to input the plurality of command signals and the generated address to the first to the M^{th} memory chips.

23. The memory system of claim 22, wherein
the memory controller sets a difference between an original maximum value and the count information having the greatest value among the pieces of first to M^{th} count information as the maximum address value.

24. The memory system of claim 23, wherein each of the first to the M^{th} memory chips comprises first to N^{th} storage units for storing the failed addresses and generates the internal address by adding an external address and a conversion value together, wherein the conversion value being a maximum value of K (1≦K<N) satisfying a condition that a sum of the external address and the K is greater than the failed address stored in the K^{th} storage unit of the first to the N^{th} storage units.

25. The memory system of claim 24, wherein each of the first to the M^{th} memory chips generates the internal address by adding N and the external address together if a sum of the external address and the N is greater than the failed address stored in the N^{th} storage unit.

26. A memory, comprising:
a cell array configured to include a plurality of memory cells;
a plurality of storage units configured to store a failed address;
an address mapping unit configured to map an external address to an internal address having a different value from the failed address stored in the plurality of storage units; and
a control unit configured to access memory cells designated by the internal address among the plurality of memory cells in response to an access command.

27. A memory system, comprising:
a memory configured to include a plurality of memory cells, to access memory cells designated by an internal address among the plurality of memory cells in response to a plurality of command signals, to count a number of failed addresses, and to generate count information based on a result of the count; and
a memory controller configured to set a maximum address value in response to the count information, to generate an address having a value between a minimum address value and the maximum address value, and to input the plurality of command signals and the generated address to the memory,
wherein the memory maps an address, which is received from the memory controller, to the internal address so that the received address has a different value from the failed address.
